(19) United States
(12) Patent Application Publication
(10) Pub. No.: US 2016/0348036 A1
(43) Pub. Date: Dec. 1, 2016

(54) MACHINE DISHWASH COMPOSITION

(71) Applicant: CONOPCO, INC., D/B/A UNILEVER, Englewood Cliffs, NJ (US)

(72) Inventors: Olaf Cornelis Petrus BEERS, Delfgauw (NL); Thomas Andreas BUITELAAR, Maasland (NL); Michaël Carolus M GRIBNAU, Vlaardingen (NL)

(73) Assignee: Conopco, Inc., d/b/a UNILEVER, Englewood Cliffs (US)

(21) Appl. No.: 15/118,987

(22) PCT Filed: Jan. 26, 2015
(86) PCT No.: PCT/EP2015/051464

§ 371 Date: Aug. 15, 2016

(30) Foreign Application Priority Data
Feb. 20, 2014 (EP) 14155989.8

(51) Int. Cl. C11D 3/39; C11D 3/08; C11D 3/20; C11D 3/37; C11D 3/33; C11D 1/66; C11D 3/10

(52) U.S. Cl. CPC C11D 3/3932; C11D 1/66; C11D 3/08; C11D 3/10; C11D 3/3942; C11D 3/3757; C11D 3/33; C11D 3/2086

(57) ABSTRACT

The present invention relates to a zero-phosphate machine dish wash composition in unit dose format comprising non-phosphate builder, alkali percarbonate, a manganese bleach catalyst in relatively low amounts and one or more polycarboxylate polymers. The builder comprises one or more from methylglycine-N,N-diacetic acid and/or one or more salts thereof, citric acid and/or one or more salts thereof, and glutamic acid-N,N-diacetic acid and/or one or more salts thereof. The polycarboxylate polymers have a weight average molecular weight of between 1000 and 100,000, the polymers comprising at least 20 mol-% of acrylate monomers and from 0 to 40 mol-% of maleate monomers. The composition provides improved tea stain removal upon use.

### FIELD OF THE INVENTION

The present invention is in the field of machine dishwashing. More specifically, the invention encompasses automatic dishwashing detergents and their use in a dish washing process.

### BACKGROUND TO THE INVENTION

Automatic dishwashing machines have become a commodity in many households. The benefits of such machines to consumers, such as a reduced effort in cleaning crockery and cutlery, are crucially dependent on the type of detergent composition used during automatic dishwashing.

Therefore, detergent formulations typically contain a number of different active components, including builders, surfactants, enzymes and bleaching agents. Builders (complexing agents) are commonly applied in detergent compositions in order to negate the negative effects of calcium and magnesium ions on the removal of soils by detergent compositions. Moreover, builders act to reduce or negate the visual effects of scaling on hard surfaces. Phosphorous based builders, such as phosphates, have been used for many years in a wide variety of detergent compositions. However, as part of an increasing trend towards environmentally friendly detergent compositions, alternative building agents have been developed and these alternative builders have found their way into commercial detergent products.

Known alternative zero-phosphate builders are for example salts of citric acid and salts of amino polycarboxylate compounds such as methylglycine-N,N-diacetic acid (MGDA) and glutamic-N,N-diacetic acid (GLDA).

One of the toughest types of stains in the field of machine dishwashing is the tea stain, the brown-greyish stain that remains in tea cups after their use in particular when tea was brewed with hard water. Therefore, the removal of tea stains plays an important role in consumer perception and satisfaction about a machine dishwash formulation.

In view of environmental impact and of efficiency, it is a constant objective of research into detergent formulations to reduce the amounts of individual ingredients and the total dose of detergent formulation required. However, reducing the amount of active ingredients will generally lead to a lower performance, in particular also with respect to tea stain removal.

It is generally recognised that a bleaching system is required as a component in any machine dishwash composition. In view of its efficacy, a system involving an inorganic bleach precursor (including for example sodium percarbonate) is particularly desirable.

A known way to improve the performance of a machine dishwash composition is to provide a bleach catalyst, such as a manganese catalyst in combination with the inorganic bleach precursor. For example EP 1741774 A1 discloses an automatic machine dishwashing composition comprising a nonionic surfactant, a peroxygen bleach compound and a dinuclear manganese-complex. The dinuclear manganese complex has the general formula:

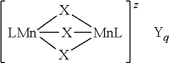

wherein Mn is manganese which can individually be in the III or IV oxidation state; each x represents a coordinating or bridging species (for example O²⁻) and L is a ligand which is an organic molecule containing a number of nitrogen atoms which coordinates via all or some of its nitrogen atoms to the manganese centres; z denotes the charge of the complex; Y is a monovalent or multivalent counter-ion, leading to charge neutrality, which is dependent upon the charge z of the complex; and q=^{z/}[charge Y]

Therefore, a composition including such a combination of bleach precursor and catalyst is highly desirable. However, despite their advantages, the bleach precursors and catalysts have drawbacks too. The catalysts are expensive and too high levels of them may lead to discolorations. Inorganic bleach precursors are associated exothermal degradation, leading to possible self-heating of formulations containing them, such that stabilisation requirements increase with their level in a formulation. Therefore, it would be desirable to reduce the amounts of inorganic bleach precursor and or manganese catalyst in a composition, without compromising the cleaning efficacy, in particular the tea stain removal, of the composition.

Another aspect is the desire for so-called unit dose compositions. Consumers appreciate the ease of using such pre-dosed compositions. Moreover, providing the consumer with such a clear dose may also help in reducing the tendency of overdosing and therefore provide a sustainability advantage. Tablets are a well-known unit dose format. Water-soluble containers such as pouches comprising powder and/or gel portions are also known.

For example, US 2011/0265829 A1 relates to a water soluble multi-compartment pouch adapted to fit in the dishwasher dispenser. In particular it discloses a unit dose machine dishwashing article comprising a pouch comprising a powder composition comprising manganese trizacyclononane or a related complex.

In addition, many consumers prefer a composition of the so-called “all-in-one” type, without the need for separate dosing of regenerating salt for ion exchange resins and/or rinse aids.

Traditional machine dish wash formulations in powder form need to be dosed by the consumer. Typically, such formulations require relatively large doses of around 30 grams or more. However, when powders are used in a unit dose format (for instance in a pouch- or blister-type of packaging) such amounts would generally be perceived as too high, because they would make the unit dose too bulky and might for instance make it difficult to fit into the dosing compartment of a dishwashing machine.

Moreover, it is a general problem that a unit dose formulation (especially an all-in-one formulation) should be more robust than a continuously dosable formulation such as a classical powder product, because it is not easy for consumers to adapt the dose to their particular needs at a particular moment, depending for instance on the amount of dishware, and the type amount and type of soil to be removed. Therefore, reducing the amounts of builder, bleach and bleach catalyst in such compositions provides a particular challenge.

Therefore it is an object of the present invention to improve the performance of zero-phosphate machine dishwash compositions in unit dose format, especially such compositions wherein a substantial part of the composition is in powder form.

More in particular it is an object of the present invention to provide unit dose machine dishwash compositions that provide the same or preferably improved tea stain removal upon use despite the presence of reduced amounts of components such as builder, bleach and bleach catalyst compared to existing formulations.

It is a further object of the present invention to provide such unit dose compositions that are suitable for use as a product of the “all-in-one” or “multifunctional” type.

There is a general trend towards using shorter dishwashing programs in dishwashing machines. Consequently, the time available for the detergent composition to work on stains and soils is also reduced. It is therefore also an object of the present invention to provide zero-phosphate dishwash compositions in unit dose format that are capable of providing the above benefits in a relatively short washing cycle, for example a cycle with a hold time at the washing temperature (typically 50-55° C.) of less than ten minutes, in particular about eight minutes.

### SUMMARY OF THE INVENTION

We have found that one or more of these objects can be achieved by the composition of the present invention. In particular, we have now found that the tea stain removal performance of unit dose machine dish wash compositions with relatively small amounts of non-phosphate builder, bleach and bleach catalyst, can be increased by the addition of an amount of a polycarboxylate polymer with a weight average molecular weight of between 1000 and 100 000, whereby the polymer comprises at least 60 mol-% of acrylate monomers.

Therefore, according to a first aspect, the present invention provides a zero-phosphate machine dish wash composition in unit dose format comprising
a. non-phosphate builder in an amount A, being in the range of 1 to 10 grams, the builder comprising one or more from methylglycine-N,N-diacetic acid and/or one or more salts thereof in an amount A1,
   citric acid and/or one or more salts thereof in an amount A2, and
   glutamic acid-N,N-diacetic acid and/or one or more salts thereof in an amount A3,
   whereby the amounts of the non-phosphate builder and its components are expressed as the molar equivalent amounts of the respective neutralised sodium salts;
b. alkali percarbonate in an amount B, being in the range of 0.06 to 0.7 grams in terms of active oxygen;
c. one or more polycarboxylate polymers with a weight average molecular weight of between 1000 and 100,000, the polymers comprising at least 20 mol-% of acrylate monomers and from 0 to 40 mol-% of maleate monomers, whereby the polycarboxylate polymers are present in an amount C, being in the range of 0.2 to 3 grams, and whereby the weight of the polymers is expressed in terms of the weight of the molar equivalent amounts of their neutralised sodium salts;
d. alkali carbonate, alkali silicates or mixtures thereof in an amount D, being in the range of 1 to 10 grams;
e. one or more nonionic surfactants in a total amount E, being in the range of 0 to 2 grams;
f. a manganese bleach catalyst in an amount F, being in the range of 0.0020 to 0.018 grams, whereby the manganese bleach catalyst is according to formula (I):

[LₙMnₘXₚ]^{z}Y_{q} (I)
wherein Mn is manganese; n and m are independent integers from 1 to 4; each Mn independently has an oxidation state selected from II, Ill, IV and V; X represents a coordination or bridging species; p is an integer from 0 to 12; Y is a counter-ion, the type of which is dependent upon the charge z of the complex which can be positive, zero or negative; the coefficient q is the charge z divided by the charge of Y; and L is a ligand being a macrocyclic organic molecule of the general formula (II)

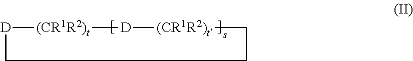

wherein R¹ and R² can each be zero, H, alkyl or aryl; t and t′ are each independent integers from 2 to 3; each D can independently be N, NR, PR, O, or S, wherein R is H, alkyl or aryl; and s is an integer from 2 to 5; whereby the weight of the bleach catalyst is expressed as the weight of the molar equivalent amount of the complex wherein L is 1,4,7-trimethyl-1,4,7-triazacyclononane, m is 2, X is O²⁻, p is 3, z is 2+, Y is PF₆⁻ and q is 2;
g. and optionally, further ingredients;
whereby the sum of the said amounts A, B, C, D, and E is between 5 and 25 grams;
whereby all amounts are specified with regard to the anhydrous compound; and
whereby the amounts A1, A2, A3, B, and F satisfy the relationship (R):

1.75×A1+1.43×A2+1.54×A3+9.83×B+153×F=S,
wherein S≦16.34 grams
whereby the composition is such that the pH of a solution of 1 wt % of the composition in water has a pH above 9.5 at 20° C.,
and whereby at least 40 wt-% of the composition is in powder form.

The tea stain removal efficiency can adequately be quantified by the tea stain score TSS as is described in this description.

As stated above, the present invention involves combining specific builders, an inorganic bleach precursor and a specific bleach catalyst with a class of polycarboxylate polymers. Therefore, according to a second aspect, the invention relates to the use of one or more polycarboxylate polymers for raising the tea stain score TSS of a zero-phosphate machine dish wash composition in unit dose format with respect to the same composition without the polycarboxylate polymers;

the polymers having a weight average molecular weight of between 1000 and 100,000 and comprising at least 20 mol-% of acrylate monomers and from 0 to 40 mol-% of maleate monomers, whereby the one or more polymers are present in an amount C, being in the range of 0.2 to 3 grams; whereby the composition additionally comprises
a. non-phosphate builder in an amount A, being in the range of 1 to 10 grams, the builder comprising one or more from methylglycine-N,N-diacetic acid and/or one or more salts thereof in an amount A1,
   citric acid and/or one or more salts thereof in an amount A2, and
   glutamic acid-N,N-diacetic acid and/or one or more salts thereof in an amount A3,
   whereby the amounts of the non-phosphate builder and its components are expressed as the molar equivalent amounts of the respective neutralised sodium salts;
b. alkali percarbonate in an amount B, being in the range of 0.06 to 0.7 grams in terms of active oxygen;
c. alkali carbonate, alkali silicates or mixtures thereof in an amount D, being in the range of 1 to 10 grams;
d. one or more nonionic surfactants in a total amount E, being in the range of 0 to 2 grams;
e. a manganese bleach catalyst in an amount F, being in the range of 0.0020 to 0.018 grams, whereby the manganese bleach catalyst is according to formula (I):

[LₙMnₘXₚ]^{z}Y_{q} (I)
wherein Mn is manganese; n and m are independent integers from 1 to 4; each Mn independently has an oxidation state selected from II, Ill, IV and V; X represents a coordination or bridging species; p is an integer from 0 to 12; Y is a counter-ion, the type of which is dependent upon the charge z of the complex which can be positive, zero or negative; the coefficient q is the charge z divided by the charge of Y; and L is a ligand being a macrocyclic organic molecule of the general formula (II)

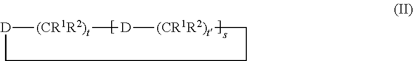

wherein R¹ and R² can each be, zero, H, alkyl or aryl; t and t′ are each independent integers from 2 to 3; each D can independently be N, NR, PR, O, or S, wherein R is H, alkyl or aryl; and s is an integer from 2 to 5; whereby the weight of the bleach catalyst is expressed as the weight of the molar equivalent amount of the complex wherein L is 1,4,7-trimethyl-1,4,7-triazacyclononane, m is 2, X is O²⁻, p is 3, z is 2+, Y is PF₆⁻ and q is 2;
f. and, optionally, further ingredients;
whereby the sum of the said amounts A, B, C, D, and E is between 5 and 25 grams;
whereby all amounts are specified with regard to the anhydrous compound; and whereby the amounts A1, A2, A3, B, and F satisfy the relationship (R):

1.75×A1+1.43×A2+1.54×A3+9.83×B+153×F=S,
wherein S≦16.34 grams;
whereby the composition is such that the pH of a solution of 1 wt % of the composition in water has a pH above 9.5 at 20° C.

According to a third aspect, the present invention also relates to use of a composition according to the invention for improving tea stain removal upon dishwashing.

### DETAILED DESCRIPTION OF THE INVENTION

Definitions

For the avoidance of doubt, any feature of one aspect of the present invention may be utilised in any other aspect of the invention. The word “comprising” is intended to mean “including” but not necessarily “consisting of” or “composed of.” Thus, the term “comprising” is meant not to be limiting to any subsequently stated elements but rather to optionally also encompass non-specified elements of major or minor functional importance. In other words, the listed steps or options need not be exhaustive. Whenever the words “including” or “having” are used, these terms are meant to be equivalent to “comprising” as defined above. It is noted that the examples given in the description below are intended to clarify the invention and are not intended to limit the invention to those examples per se.

Except in the examples, or where otherwise explicitly indicated, all numbers in this description indicating amounts of material or conditions of reaction, physical properties of materials and/or use are to be understood as modified by the word “about”. Unless specified otherwise, numerical ranges expressed in the format “from x to y” are understood to include x and y. When for a specific feature multiple preferred ranges are described in the format “from x to y”, it is understood that all ranges combining the different endpoints are also contemplated.

Weight percentages (indicated as ‘wt. %’) herein are calculated based upon total weight of the composition, unless indicated otherwise.

Whenever an amount or concentration of a component is quantified herein, unless indicated otherwise, the quantified amount or quantified concentration relates to said component per se, even though it may be common practice to add such a component in the form of a solution or of a blend with one or more other ingredients.

Throughout this description all amounts are specified with regard to the anhydrous and pure compound (without contaminations), unless otherwise specified.

The relative and absolute weights of the non-phosphate builder compounds are expressed in terms of the fully neutralised sodium salt of the respective anhydrous compound, unless otherwise specified.

Similarly, the relative and absolute weights of the polycarboxylate polymers are expressed in terms of the weight of the molar equivalent amounts of their neutralised sodium salts in anhydrous form, unless otherwise specified.

Also the weights of carbonate and silicate salts are specified in terms of the weight of the anhydrous sodium salt unless otherwise specified.

In the context of this invention, ‘substantially free of’ means a maximum concentration of the compound concerned of 1 wt-% based on the total weight of the detergent composition. Phosphate free in the context of this invention means that no phosphate is added in the preparation of the detergent composition. In this context, phosphate includes polyphosphates such as tripolyphosphates.

At the instances in this specification where reference is made to amino (poly)carboxylic acids the corresponding salts are meant to be included as well.

Type of Machine Dishwash Composition

Traditionally, a consumer would use three or more products to wash dishes in an automatic dishwashing machine. Salt would be added to the salt compartment to soften water. A dishwashing detergent composition would serve to clean the articles, and a rinse aid would be used in the final steps of the dishwashing process to avoid spots, streaks and smears on the articles. A machine dishwashing detergent composition suitable for that type of application is referred to as a standard machine dishwash detergent composition or standard product.

In recent years these traditional standard machine dishwash detergent products have at least partly been replaced by products that are referred to as “2 in 1” products and “3 in 1” products. Such “2 in 1” products comprise the salt-function already built into the product and therefore in use, there is no longer a need to add salt to the salt compartment of the washing machine.

A rinse aid is still separately added. Similarly, “3 in 1” products obviate the need for salt addition and rinse aid addition. The three desired functions of cleaning, rinsing and softening are included in one product. Other multifunctional products have been developed in recent years, such as 4-in-1 and 5-in-1 detergent products have been developed, for example with glass protection functionality and/or water-soluble wraps. All these “all-in-one”-type products are further referred to as multifunctional compositions.

The present invention is applicable to both standard and to multifunctional products. However, the intended applicability may have consequences for the composition of the detergent as will become apparent in this description.

The invention is in particular suitable for multifunctional machine dishwash detergent compositions. Therefore, the composition of the present invention preferably is a multifunctional composition. However, benefits can also be achieved by applying the invention to a detergent composition in which a separate rinse aid is used in the final steps of the dishwashing process. In an alternative preferred embodiment, the detergent composition is a standard machine dishwash detergent composition.

Non-Phosphate Builder

In the context of this description, the non-phosphate builder is defined as including low-molecular weight compounds displaying building efficacy, such as citrate, MGDA and GLDA. These compounds are capable of binding calcium and/or magnesium ions. Alkali carbonate salts (such as Na₂CO₃ and K₂CO₃) and alkali silicates are not included in the non-phosphate builder as defined here.

The non-phosphate builder comprises one or more from methylglycine-N,N-diacetic acid and/or one or more salts thereof, citric acid and/or one or more salts thereof, and glutamic acid-N,N-diacetic acid and/or one or more salts thereof.

Methylglycine-N,N-diacetic acid, citric acid and glutamic acid-N,N-diacetic acid are compounds known in the art as chelating agents and detergent builders. Methylglycine-N,N-diacetic acid is generally referred to as MGDA. Glutamic acid-N,N-diacetic acid is generally referred to as GLDA. When used herein, any reference to Methylglycine-N,N-diacetic acid, MGDA, glutamic acid-N,N-diacetic acid, or GLDA, without further indication of the degree of neutralization refers to the respective acid and any (partial) salt thereof.

Preferably, at least 80 wt-%, more preferably at least 90 wt-%, even more preferably at least 95 wt-%, and still more preferably at least 99 wt-% of the non-phosphate builder is selected from methylglycine-N,N-diacetic acid (MGDA), one or more salts thereof, citric acid, one or more salts thereof, glutamic acid-N,N-diacetic acid, one or more salts thereof, and mixtures of these acids and salts.

MGDA and citric acid are preferred builders. Therefore, it is preferred that at least 80 wt-%, preferably at least 90 wt-%, more preferably at least 95 wt-%, and still more preferably at least 99 wt-% of the non-phosphate builder is selected from methylglycine-N,N-diacetic acid (MGDA), citric acid, their respective salts, and mixtures thereof.

In certain embodiments, MGDA is the most preferred builder. Therefore, preferably, at least 80 wt-% more preferably at least 90 wt-%, even more preferably at least 95 wt-%, and still more preferably at least 99 wt-% of the non-phosphate builder is methylglycine-N,N-diacetic acid, one or more salts thereof, and mixtures of this acid and these salts. In some applications it is even preferred that the non-phosphate builder consists substantially of methylglycine-N,N-diacetic acid, one or more salts thereof, and mixtures of this acid and these salts. The MGDA is preferably present as its fully neutralised alkali salt, more preferably its sodium salt.

Alternatively, in other embodiments, citric acid is the most preferred builder. Therefore, preferably at least 80 wt-% more preferably at least 90 wt-%, even more preferably at least 95 wt-%, and still more preferably at least 99 wt-% of the non-phosphate builder is citric acid, one or more salts thereof, and mixtures of this acid and these salts. In some applications it is even preferred that the non-phosphate builder consists substantially of citric acid, one or more salts thereof, and mixtures of this acid and these salts. The citric acid is preferably present as its fully neutralised alkali salt, more preferably its sodium salt.

The composition comprises non-phosphate builder in an amount A, being in the range of 1 to 10 grams,

The amount of the builder depends inter alia on whether the composition is intended for use as a standard or a multifunctional detergent product. Multifunctional products need to be able to cope with a higher water hardness and therefore generally comprise a larger amount of non-phosphate builder than standard products.

Thus, in case the composition is a multifunctional machine dishwash detergent composition, the amount A of the non-phosphate builder is preferably in the range of 5 to 9 grams, even more preferably from 6 to 8 grams.

Conversely, if the composition is a standard machine dishwash detergent composition, the amount A of the non-phosphate builder is preferably in the range of 1 to 5 grams, even more preferably from 1.5 to 4 grams.

MGDA is present in an amount A1, citric acid in an amount A2 and GLDA in an amount A3. Consequently, these amounts A1, A2, A3, and the amount of any other non-phosphate builder present sum up to the amount A.

In case MGDA is the only non-phosphate builder present, the amount A1 is equal to the amount A. If in that case the composition is a multifunctional detergent product, the amount A1 is preferably in the range of 5 to 9 grams, even more preferably from 6 to 8 grams; and if the composition is a standard product, the amount A1 is preferably in the range of 1 to 5 grams, even more preferably from 1.5 to 4 grams.

In case citric acid is the only non-phosphate builder present, the amount A2 is equal to the amount A. If in that case the composition is a multifunctional detergent product, the amount A2 is preferably in the range of 5 to 9 grams, even more preferably from 6 to 8 grams; and if the composition is a standard product, the amount A2 is preferably in the range of 1 to 5 grams, even more preferably from 1.5 to 4 grams.

In case GLDA is the only non-phosphate builder present, the amount A3 s equal to the amount A. If in that case the composition is a multifunctional detergent product, the amount A3 is preferably in the range of 5 to 9 grams, even more preferably from 6 to 8 grams; and if the composition is a standard product, the amount A3 is preferably in the range of 1 to 5 grams, even more preferably from 1.5 to 4 grams.

The form in which the MGDA and/or citric acid and/or GLDA and/or their salts can be applied in the compositions can be any, such as a powder or a granule or a solution, and is suitably chosen depending in the format of the detergent composition foreseen.

Alkali Percarbonate

The alkali percarbonate is an inorganic bleach percursor capable of releasing peroxide during dishwashing. The alkali percarbonate preferably is sodium percarbonate.

The amount of alkali percarbonate is expressed in terms of the amount or percentage of active oxygen that can be delivered by the compound. For example, 1 g of pure anhydrous sodium percarbonate (Na₂CO₃)₂.3H₂O₂) corresponds to 0.153 g in terms of active oxygen.

The alkali percarbonate is preferably present in an amount B of between 0.15 and 0.6 grams, more preferably between 0.2 and 0.5 grams and even more preferably, between 0.3 and 0.45 grams in terms of active oxygen.

The alkali percarbonate may be present in a powdered or granulated form. It is preferably present in granulated form.

Bleach Catalyst

The manganese bleach catalyst is present in an amount F, being in the range of 0.0020 to 0.018 grams, preferably 0.0040 to 0.015 grams, more preferably 0.0060 to 0.0120 grams and even more preferably 0.0070 to 0.0090 grams.

The manganese bleach catalyst is according to formula (I):

[LₙMnₘXₚ]^{z}Y_{q} (I)

wherein Mn is manganese; n and m are independent integers from 1 to 4. Both n and m are preferably 1 or 2, and even more preferably n=m=2. Each Mn independently has an oxidation state selected from II, Ill, IV and V, preferably selected from III and IV.

X represents a coordination or bridging species including for example H₂O, OH⁻, O²⁻, S₂⁻,HOO⁻, O₂²⁻, O₂¹⁻, R—COO⁻, with R being H, alkyl, aryl, optionally substituted, NR₃ with R being H, alkyl, aryl, optionally substituted, Cl⁻, SCN⁻, N₃⁻, etc. or a combination thereof. Preferably X represents O²⁻ or (OAc)⁻, more preferably O²⁻. Here, Ac signifies an acyl group. The coefficient p is an integer from 0 to 12, preferably from 3 to 6. Y is a counter-ion, the type of which is dependent upon the charge z of the complex which can be positive, zero or negative. If z is positive, Y is an anion, such as Cl⁻, Br⁻, I⁻, NO₃⁻, ClO₄⁻, NCS⁻, PF₆⁻, RSO₄⁻, OAc⁻, BPh₄⁻, CF₃SO₃⁻, RSO₃⁻, RSO₄⁻, etc., where R represents alkyl, or aryl. Preferably, Y is PF₆⁻ or ClO₄⁻. If z is negative, Y is a cation, such as an alkali metal, alkaline earth metal or (alkyl)ammonium cation, etc.

The coefficient q is the charge z divided by the charge of Y; and L is a ligand being a macrocyclic organic molecule of the general formula (II)

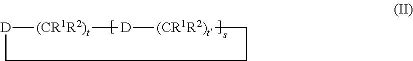

wherein R¹ and R² can each be zero, H, alkyl or aryl; t and t′ are each independent integers from 2 to 3; each D can independently be N, NR, PR, 0, or S, wherein R is H, alkyl or aryl. Preferably, D is NR. If a D is N, one of the hetero-carbon bonds attached thereto may be unsaturated, e.g. giving rise to an —N═CR¹-fragment, R² being zero. The coefficient s is an integer from 2 to 5; that is, s is 2, 3, 4, or 5. Preferably, s is 2, 3, or 4, even more preferably s is 2.

Preferred ligands L are those in which each D is independently selected from NH or NR, t and t′ are 2 or 3, s=2 and R¹50 R²═H, more preferably wherein at least one D is NCH₃ and t=t′=2. Other preferred ligands L are those wherein each D is NCH₃; t=t′=2; s=2 and R¹ and R² can each be H or alkyl. Examples of such preferred ligands are provided in EP-A-0 458 397.

Particularly preferred ligands are 1,4,7-trimethyl-1,4,7-triazacyclononane, coded as Me-TACN, 1,4,7-triazacyclononane, coded as TACN, 1,5,9-trimethyl-1,5,9-triazacyclododecane, coded as Me-TACD; 2-methyl-1,4,7-trimethyl-1,4,7-triazacyclononane, coded as Me/Me-TACN and 2-methyl-1,4,7-triazacyclononane, coded as Me/TACN. Of these ligands, Me-TACN and Me/Me-TACN are the most preferred.

Examples of suitable manganese bleach catalysts are provided in EP-A-0 458 397.

It is preferred that the manganese bleach catalyst comprises one or more from

[Mn^{III}₂(μ-O)₁(μ-OAc)₂(Me-TACN)₂(ClO₄)₂,

[Mn^{III}Mn^{IV}(μ-O)₁(μ-OAc)₂(Me-TACN)₂](ClO₄)₃,

[Mn^{IV}₂(μ-O)₃(Me-TACN)₂](PF₆)₂, and

[Mn^{IV}₂(μ-O)₃(Me/Me-TACN)₂](PF₆)₂

It is even more preferred that the manganese bleach catalyst comprises one or more from [Mn^{IV}₂(μ-O)₃(Me-TACN)₂](PF₆)₂, and [Mn^{IV}₂(μ-O)₃(Me/Me-TACN)₂](PF₆)₂. It is still more preferred that the manganese bleach catalyst is [Mn^{IV}₂(μ-O)₃(Me-TACN)₂](PF₆)₂.

The weight of the amount F of the bleach catalyst is expressed as the weight of the molar equivalent amount of the complex wherein L is 1,4,7-trimethyl-1,4,7-triazacyclononane, m is 2, X is O²⁻, p is 3, z is 2+, Y is PF₆⁻ and q is 2.

This bleach catalyst may suitably be present in the composition in the form of a granule, in particular a granulate comprising a carrier. Such a granulate provides accurate dosing and enhanced storage stability and preferably aids to separate the catalyst from the bleach particles during storage (to avoid premature bleach activation).

Polycarboxylate Polymers

The polycarboxylate polymers surprisingly improve the tea stain removal upon machine dishwashing with the composition of the present invention comprising relatively small amounts of non-phosphate builder, bleach and bleach catalyst in view of relationship R.

The composition of the invention comprises one or more polycarboxylate polymers with a weight average molecular weight of between 1000 and 100,000, the polymers comprising at least 20 mol-% of acrylate monomers and from 0 to 40 mol-% of maleate monomers, whereby the polycarboxylate polymers are present in an amount C, being in the range of 0.2 to 3 grams, and whereby the weight of the polymers is expressed in terms of the weight of the molar equivalent amounts of their neutralised sodium salts.

The amount C of the one or more polycarboxylate polymers is in the range of 0.3 to 2 grams, more preferably 0.4 to 1 grams, even more preferably from 0.5 to 0.8 grams and still more preferably from 0.6 to 0.7 grams based on the weight of the molar equivalent amount of their neutralised sodium salts.

The polymers comprise monomers comprising one or more carboxylate groups, such as acrylate and maleate, respectively. A carboxylate group is considered as a —COO⁻ moiety. Suitable polymers can be homopolymers (for example polyacrylates) or copolymers. In case the polymer is a copolymer, it can be a random, block or graft copolymer, or a combination thereof.

It is preferred that the one or more polycarboxylate polymers have a ratio of carboxylate groups to monomers of at least 0.5, preferably at least 0.75, more preferably at least 1.0, even more preferably at least 1.25. In this ratio, the monomers refer to the low molecular weight monomers constituting the polymers, such as acrylates and maleates. Thus, in case of graft polymers, the graft chains are not considered as monomers, but the low MW monomers (such as, for example any ethylene, acrylic acid, maleic acid residues present) that constitute the chains are.

The polycarboxylate polymers are preferably selected from polycarboxylate polymers wherein at least 90 mol-% of the monomers are selected from acrylate, maleate, monoethylenically unsaturated alkyl sulphonic acid derivatives, monoethylenically unsaturated polyalkyleneoxide macromers and mixtures thereof.

A preferred example of a monoethylenically unsaturated alkyl sulphonic acid derivative is 2-acrylamido-2-methylpropanesulphonic acid. Sokolan CP50 (ex BASF) is an example of a polymer including such monomers. A preferred example of monoethylenically unsaturated polyalkyleneoxide macromers, are polyethylenoxide macromers. Inclusion of such macromers yields a graft copolymer, such as for instance Sokolan CP42 (ex BASF).

Preferably the polycarboxylate polymer comprises at least 40 mol-%, more preferably at least 60 mol-% of acrylate monomer.

Acrylate-based polymers are preferred. Therefore, it is particularly preferred that the polycarboxylate polymers comprise one or more polyacrylate polymers with a weight average molecular weight of between 1000 and 15000, more preferably between 2000 and 9000, even more preferably between 3000 and 5000, wherein the polyacrylate polymer comprises at least 90 mol-% acrylate monomers.

Preferably the polycarboxylate polymers comprise at least 50 wt-%, more preferably at least 60 wt-%, even more preferably at least 75 wt-%, and still more preferably at least 90 wt-% of one or more polyacrylate polymers with a weight average molecular weight of between 1000 and 15000, more preferably between 2000 and 9000, even more preferably between 3000 and 5000, wherein the polyacrylate polymer comprises at least 90 mol-% acrylate monomers. It is even more preferred that the polycarboxylate polymer is a polyacrylate polymer with a weight average molecular weight of between 1000 and 15000, more preferably between 2000 and 9000, even more preferably between 3000 and 5000, wherein the polyacrylate polymer comprises at least 90 mol-% acrylate monomers. Sokalan PA25CL (ex BASF) is an example of such a polyacrylate polymer.

Thus it is preferred that the composition of the present invention comprises the polycarboxylate polymer in an amount C, being in the range of 0.2 to 3 grams, more preferably in the range of 0.3 to 2 grams, more preferably 0.4 to 1 grams, even more preferably from 0.5 to 0.8 grams and still more preferably from 0.6 to 0.7 grams, whereby at least 90 wt-% of the polycarboxylate polymer is a polyacrylate polymer with a weight average molecular weight of between 3000 and 5000 and wherein the polyacrylate polymer comprises at least 90 mol-% acrylate monomers.

Alternatively, it is preferred that the polycarboxylate polymers comprise one or more polyacrylate-maleate co-polymers comprising from 5 to 40 mol-%, more preferably from 10 to 20 mol-% of maleate monomers. In that case, it is preferred that the polycarboxylate polymers comprise at least 50 wt-%, more preferably at least 60 wt-%, even more preferably at least 75 wt-%, and still more preferably at least 90 wt-%of one or more polyacrylate-maleate co-polymers comprising from 5 to 40 mol-%, more preferably from 10 to 20-% of maleate monomers. It is in this case particularly preferred that the polycarboxylate polymer is a polyacrylate-maleate co-polymer comprising from 5 to 40 mol-%, more preferably from 10 to 20-% of maleate monomers. Sokolan CP5 (ex BASF) is an example of such a co-polymer.

Therefore, it is also preferred that the composition of the present invention comprises the polycarboxylate polymer in an amount C, being in the range of 0.2 to 3 grams, more preferably in the range of 0.3 to 2 grams, more preferably 0.4 to 1 grams, even more preferably from 0.5 to 0.8 grams and still more preferably from 0.6 to 0.7 grams, whereby at least 90 wt-% of the polycarboxylate polymer is a polyacrylate-maleate co-polymer comprising from 10 to 20 mol-% of maleate monomers and at least 60 mol-% of acrylate monomers.

Combinations of preferred polymers are also preferred. Therefore, in another alternative, it is preferred that the composition of the present invention comprises the polycarboxylate polymer in an amount C, being in the range of 0.2 to 3 grams, more preferably in the range of 0.3 to 2 grams, more preferably 0.4 to 1 grams, even more preferably from 0.5 to 0.8 grams and still more preferably from 0.6 to 0.7 grams, whereby at least 90 wt-% of the polycarboxylate polymer is selected from (a) polyacrylate polymers with a weight average molecular weight of between 3000 and 5000 and wherein the polyacrylate polymer comprises at least 90 mol-% acrylate monomers and (b) polyacrylate-maleate co-polymers comprising from 10 to 20 mol-% of maleate monomers and at least 60 mol-% of acrylate monomers.

Alkali Carbonate and Alkali Silicates

Alkali carbonate and alkali silicates are primarily present to regulate the pH of the composition. The alkali carbonate preferably is sodium carbonate. The alkali silicate preferably is an alkali disilicate, and more preferably it is sodium disilicate, because disilicates also provide a care benefit to the composition.

The amount D of alkali carbonate, alkali silicates or mixtures thereof is preferably from 2 to 9 grams, more preferably from 3 to 8 grams and still more preferably from 4 to 7 grams.

Nonionic Surfactants

The composition according to the invention comprises one or more nonionic surfactants in a total amount E, being in the range of 0 to 2 grams.

In case the composition is a multifunctional machine dishwash detergent composition, the amount E is preferably in the range of 0.1 to 1.5 grams, more preferably 0.2 to 1.0 grams and even more preferably 0.4 to 0.8 grams.

Alternatively, in case the composition is a standard machine dishwash detergent composition, the amount E is preferably in the range of 0.1 to 0.5 grams, more preferably 0.1 to 0.3 grams.

Suitable nonionic surfactants are well-known to the skilled person in the field of machine dishwashing. These nonionic surfactants may for instance include any alkoxylated nonionic surface-active agent wherein the alkoxy moiety is selected from the group consisting of ethylene oxide, propylene oxide, butylene oxide, and mixtures thereof. The nonionic surfactants are preferably used to improve the detergency and to suppress excessive foaming due to protein soil. Examples of suitable nonionic surfactants are low- to non-foaming ethoxylated and/or propoxylated straight chain fatty alcohols.

Another class of suitable nonionic surfactants is formed by the group of C₁₀-C₁₈ alkyl dimethylamine oxides. A C₁₄-C₁₈ alkyl dimethylamine oxide is particularly suitable, such as for example, Empigen™ OD (supplied by Huntsman).

In addition to such non-end capped ethoxylated glycol ethers and amine oxides indicated above, further nonionic surfactants can be present. Further improvement of performance benefits can be obtained when the one or more nonionic surfactants furthermore include a nonionic surfactant of the formula R³—(PO)ₓ(EO)_{y}—CH₂CH(OH)—R⁴; wherein R³ is C₆-C₁₅; R⁴ is C₄-C₁₀, and x is an integer in the range of 0-10, and y is an integer in the range of 3-30. Suitable nonionics of this type include modified fatty alcohol polyglycolethers available as Dehypon® 3697 GRA or Dehypon® Wet from BASF.

Further Ingredients

In addition to the ingredients specified above, the composition of the present invention may optionally comprise other suitable ingredients well-known in the field of machine dishwash compositions. Such ingredients include for instance enzymes, anti-corrosion agents, perfumes, anti-foaming agents, anti-tarnishing agents, and crystal growth inhibitors, anti-scaling agents, anti-spotting agents, colorants, detergent surfactants, and water.

Amounts

The sum of the said amounts A of the non-phosphate builder, B of alkali percarbonate, C of the one or more polycarboxylate polymers, D of the alkali carbonate and silicate, and E of the nonionic surfactant is preferably between 8 and 23 grams, more preferably between 10 and 22 grams, even more preferably between 15 and 20 grams.

The total weight of the composition in unit dose format will be larger than the indicated sum, by virtue of the presence of (optional) components not included in the sum.

The amounts A1, A2, A3, B, and F satisfy the relationship (R):

1.75×A1+1.43×A2+1.54×A3+9.83×B+153×F=S,

wherein S≦16.34 grams.

The surprising effect on tea stain removal that is the object of this invention is observed when this relationship is satisfied.

Preferably the amounts A1, A2, A3, B, and F satisfy the relationship (R) wherein 12.34≦S≦16.34, more preferably 12.34≦S≦15.34, even more preferably 12.84≦S≦14.84, even more preferably 13.34≦S≦14.34.

Product Format

The composition of the present invention is in unit dose format. This means that is in a format suitable for dosing as a discrete portion. At least 40 wt-% of the composition is in powder form, preferably at least 50 wt-%, more preferably at least 60 wt-%, even more preferably 70 wt-%, still more preferably 80 wt-%, and even more preferably 90 wt-% of the composition is in powder form.

For a part or the whole of the composition, being in powder form means that it consists of discrete particles, preferably with a particle size distribution with a weight average particle diameter in the range of 300 to 800 μm, containing less than 8 wt-% of fines with a particle size below 180 μm and less than 10 wt-% of particles with a diameter larger than 1000 μm. The weight-based diameter of a particle refers to the diameter of a spherical particle of the same weight as the particle, as known to the skilled person.

The part of the composition that is in powder form is preferably separate from the other parts of the composition that are not in powder form. Thus, for example, the product may be packaged in a multi-compartment-type of packaging.

The part of the composition that is in powder form preferably comprises the non-phosphate builder. It also preferably comprises the alkali percarbonate. It also preferably comprises the alkali carbonate and alkali sicilates. It also preferably comprises the manganese bleach catalyst.

The part of the composition that is in powder form is preferably freeflowing when taken in isolation.

The part of the composition that is not in powder form may be in any conventional form for a machine dishwash composition, such as a compressed solid shape (e.g. a tablet), a gel, a dilute or concentrated liquid or a suspension.

The unit dose typically includes a means for keeping it together. For instance the powder part and optional other parts may be packed in a water-soluble container, such as a pouch or a capsule. Examples of suitable water-soluble containers are provided for instance in WO-A-2012/027404, WO-A-2013/043841, and US-A-2011/0265829. For example, water-soluble polyvinyl alcohol (PVA) based materials are suitable for the preparation of such containers. The advantage of a water-soluble container is that it does not need to be removed before use, and prevents the user from contact between the composition and the skin, thus offering dosing convenience to the consumer. Such containers may be made in different shapes and configurations. Preferably, the container is compartmentalised. It is even more preferred that the part of the composition in powder form is in a different compartment than the parts that are not in powder form.

Alternatively, the unit dose may be packed in a container that needs to be removed before use, such as blister-type or sachet-type packaging. Such types of packaging are also preferably used in compartmentalised form, more preferably separating the part of the composition that is in powder form from the parts that are not in powder form.

The pH

The composition of the present invention is such that the pH of a solution of 1 wt % of the composition in water has a pH above 9.5 at 20° C. The pH that results upon dissolution is easily adapted such that it falls in the required range by variation of the amounts of components of differing acidity and basicity, the composition typically including components of well-known acidity and basicity.

The composition of the present invention is preferably such that the pH of a solution of 1 wt % of the composition in water has a pH above 10 and more preferably above 10.5 at 20° C. This pH requirement ensures that the pH of the wash liquor upon use is optimal for the functioning of the non-phosphate builder and the bleach catalyst. The composition is preferably such that during use of the composition the pH of the wash liquor is between 9.5 and 11 and even more preferably between 9.8 and 10.5.

Tea Stain Score (TSS)

The efficacy of a machine dish wash composition can be assessed by determining its tea stain score TSS. This TSS is determined by the test protocol described in the Examples section below. Thus the result of that test protocol is regarded as a property of the particular composition of the invention in unit dose format. The TSS can vary between 0 (no stain removal) and 10 (complete tea stain removal).

The composition according to the present invention preferably has a tea stain score TSS of at least 4, more preferably at least 5, and even more preferably at least 6. Such tea stain scores are believed to correspond to satisfactory to very good tea stain removal under normal typical conditions of consumer use of the composition.

Use of the Polycarboxylate Polymer

According to the second aspect of the invention as defined above, the invention also relates to use of one or more polycarboxylate polymers for raising the tea stain score TSS of a zero-phosphate machine dish wash composition in unit dose format with respect to the same composition without the polycarboxylate polymers.

Preferably this use is for raising the tea stain score TSS with at least one mark, more preferably at least two marks with respect to the same composition without the polycarboxylate polymers.

Preferred polycarboxylate polymers and preferred amounts thereof as expressed with respect to the composition according to the first aspect of the invention are similarly preferred with respect to the use of the one or more polycarboxylate polymers according to the second aspect of the invention.

Thus, this use of the one or more polycarboxylate polymers preferably is for improved tea stain removal or even for improved cleaning of dishware in general.

Use of the Composition

According to the third aspect of the invention, there is provided use of a composition according to the first aspect of the invention for improving tea stain removal upon dishwashing, whereby the improvement preferably is with respect to the same composition without the one or more polycarboxylate polymers.

On comparing products that were stained with tea stains and then cleaned in a machine dishwasher, the skilled person will easily be able to assess whether there is a difference in the tea stain removal between two or more objects (typically dishware objects, cups, saucers, etc.), for example by visual inspection.

Thus, the use of the composition according to the invention is preferably for contributing to generally improved cleaning of dishware.

The amounts mentioned in this specification are based on the recommended amount of detergent composition used per main wash cycle. The size, load and amount of water used may vary between different types of dishwashing machines. The unit dose machine dishwash detergent compositions according to the invention may suitably be dosed in the wash liquor at levels of from 2 g/l to 10 g/l, more preferably 4 to 6 g/l.

### EXAMPLE 1

Preparation of Soiled Tea Cups

Hard water was prepared by dissolving 6.78 g of CaCl₂.2H₂O and 2.35 g of MgCl₂.6H₂O in 16 litres of demineralised water in an electric kettle. After bringing the water to the boil, a tea infuser filled with 260 g of Lipton Yellow Label tea was dipped into the water, moved up and down five times and left in the water. The total brewing time was ten minutes. After removal of the tea infuser, 2.08 g of NaHCO₃ was added as well as 862 μl of a stock solution prepared by dissolving 1.5 g of NH₄Fe₂(SO₄)₂ in 100 ml of HCl solution (0.01 M) and adjusting to a total volume of 250 ml by the addition of demineralised water.

The resulting tea extract was then poured into sand-blasted Arzberg tea cups through a 150 μm sieve, ensuring a portion of ±80 ml of tea per cup. The filled cups were kept in an oven at 83° C. for 1 hour. One minute after removal from the oven, the tea cups were poured out in one go and placed back in the oven, which was then heated to 120° C. for one hour. Afterward, the cups were allowed to cool and stored in the dark at room temperature until further use.

Test Runs in Automatic Dishwasher

For each test run, six soiled tea cups were placed in the upper rack of a Miele GSL 1222 SC reference automatic dishwashing machine. A dose of 18 grams of the composition specified for the particular test run was placed in the dispenser and 100 ml of frozen IKW ballast soil as described in “Methods for Ascertaining the Cleaning Performance of Dishwasher Detergents (Part B, updated 2005)” [IKW working group automatic dishwashing detergents, SÖFW-Journal vol 132, iss. 8, page 35 (2006)]. The 50° C. program, with a hold time of eight minutes was run on the dishwashing machine, using water with a hardness of 35° FH. No separate ion exchanger salt or rinse aids were used.

Evaluation of Tea Stain Score (TSS)

After washing, the tea staining was evaluated by visual inspection. Each cup is given a tea stain score (TSS) in the range between 1 (worst stain removal) and 10 (best stain removal). Scores are given by comparison to reference images of soiled and washed tea cups following the IKW guidelines as described in “Methods for Ascertaining the Cleaning Performance of Dishwasher Detergents (Part B, updated 2005)” [ IKW working group automatic dishwashing detergents, SÖFW-Journal vol 132, iss. 8, page 35 (2006)]. For every test run, the reported tea stain score TSS is the average score of the six cups.

Sample Compositions

A series of machine dishwash compositions was prepared. All compositions had the same amounts of base ingredients as specified in Table 1. The amount of carbonate and the amount and type of builder, and polycarboxylate polymer varied as specified in Table 2 (amounts refer to the material as received, with purity as indicated in Table 3). Details of the materials are provided in Table 3. All compositions were made in the form of free-flowing powders. For Compositions 1:1 to 1:13, the amounts A1, A2, A3, B, and F satisfy the relationship (R):

1.75 ×A1+1.43×A2+1.54×A3+9.83×B+153×F=S (R),

wherein S≦16.34 grams; and the sum of the amounts A, B, C, D, and E is between 5 and 25 grams. The composition of Example 1:2 was determined to be 11.03.

TABLE 1

| | Amount | |
|---|---|---|
| Base ingredients | (g) | |
| Builder | see Table 2 | A |
| Sodium percarbonate | 2.34 | B |
| Polycarboxylate polymer | see Table 2 | C |
| Sodium Carbonate | see Table 2 | D |
| Sodium disilicate | 0.9000 | |
| Nonionic | 0.5400 | E |
| Manganese catalyst | 0.0081 | F |
| HEDP | 0.1782 | |
| Enzymes | 0.30 | |
| Minors | 0.26 | |

TABLE 2

| | | | | | | Polycar- | | |
|---|---|---|---|---|---|---|---|---|
| | Builder | | | | | boxylate | | |
| | MGDA | citrate | GLDA | | | polymer | | |
| Ex. | A1 | A2 | A3 | STPP | Na₂CO₃ | P1 | P2 | |
| no. | (g) | (g) | (g) | (g) | (g) | (g) | (g) | S |
| 1:1* | 6.48 | — | — | — | 3.33 | — | — | 12.95 |
| 1:2 | 6.48 | — | — | — | 3.33 | 0.67 | — | 12.95 |
| 1:3 | 6.48 | — | — | — | 3.33 | 1.08 | — | 12.95 |
| 1:4 | 6.48 | — | — | — | 3.33 | 2.16 | — | 12.95 |
| 1:5 | 6.48 | — | — | — | 3.33 | — | 0.54 | 12.95 |
| 1:6 | 6.48 | — | — | — | 3.33 | — | 1.08 | 12.95 |
| 1:7 | 6.48 | — | — | — | 3.33 | — | 2.16 | 12.95 |
| 1:8* | — | 6.34 | — | — | 6.48 | — | — | 13.40 |
| 1:9 | — | 6.34 | — | — | 6.48 | 1.08 | — | 13.40 |
| 1:10 | — | 6.34 | — | — | 6.48 | — | 1.08 | 13.40 |
| 1:11* | — | — | 7.84 | — | 3.33 | — | — | 14.00 |
| 1:12 | — | — | 7.84 | — | 3.33 | 1.08 | — | 14.00 |
| 1:13 | — | — | 7.84 | — | 3.33 | — | 1.08 | 14.00 |
| 1:14* | — | — | — | 11.62 | 3.33 | — | — | |
| 1:15* | — | — | — | 11.62 | 3.33 | 1.08 | — | |
| 1:16* | — | — | — | 11.62 | 3.33 | — | 1.08 | |

TABLE 3
Materials

| | |
|---|---|
| MGDA | Trilon M granule (containing 76% MGDA; ex BASF) |
| Citrate | Trisodium citrate, anhydrous |
| GLDA | Dissolvine GL-PD-S (containing 80% GLDA; |
| | ex AkzoNobel) |
| STPP | sodium tripolyphosphate hexahydrate |
| Na₂CO₃ | sodium carbonate |
| P1 | Polyacrylate homopolymer with weight average molecular |
| | weight (MW) of 4000 |
| P2 | Copolymer, comprising about 20 mol-% maleate and about |
| | 80 mol-% acrylate and having a weight average molecular |
| | weight (MW) of 70000. |
| Sodium | Sodium percarbonate (coated), 13.5 wt-% AvOx |
| percarbonate | |
| Manganese | [Mn^{IV}₂(μ-O)₃(Me-TACN)₂](PF₆)₂; Me-TACN = 1,4,7- |
| catalyst | trimethyl-1,4,7-triazacyclononane |
| Sodium | Na Disilicate (containing 20% water) |
| disilicate | |
| Nonionic | linear alkyl alcohol polyethoxylate |
| HEDP | tetrasodium 1-hydroxyethane-1,1-diphosphonate, 86% |
| Minors | anti-corrosion agents, perfumes, anti-foaming agent |

Results

Test runs as detailed above were performed with the compositions 1:1 to 1:13. The results are summarised in Table 4.

TABLE 4

| Ex. no | pH | score per cup | | | | | | TSS |
|---|---|---|---|---|---|---|---|---|
| 1:1* | 9.69 | 2 | 2 | 3 | 2 | 2 | 3 | 2.33 |
| 1:2 | 9.68 | 4 | 4 | 4 | 5 | 4 | 4 | 4.17 |
| 1:3 | 9.66 | 4 | 3 | 4 | 4 | 4 | 4 | 3.83 |
| 1:4 | 9.66 | 5 | 5 | 6 | 5 | 4 | 4 | 4.83 |
| 1:5 | 9.70 | 3 | 4 | 3 | 4 | 4 | 4 | 3.67 |
| 1:6 | 9.72 | 6 | 4 | 5 | 5 | 6 | 5 | 5.17 |
| 1:7 | 9.71 | 5 | 6 | 5 | 5 | 4 | 6 | 5.17 |
| 1:8* | 9.84 | 3 | 3 | 2 | 2 | 3 | 4 | 2.83 |
| 1:9 | 9.85 | 7 | 7 | 7 | 6 | 7 | 6 | 6.67 |
| 1:10 | 9.83 | 7 | 7 | 7 | 7 | 8 | 8 | 7.33 |
| 1:11* | 9.72 | 2 | 3 | 3 | 4 | 4 | 5 | 3.50 |
| 1:12 | 9.65 | 4 | 4 | 4 | 5 | 6 | 4 | 4.50 |
| 1:13 | 9.67 | 4 | 5 | 7 | 5 | 7 | 6 | 5.67 |
| 1:14* | 9.60 | 4 | 5 | 5 | 5 | 4 | 5 | 4.67 |
| 1:15* | 9.54 | 4 | 4 | 4 | 5 | 5 | 4 | 4.33 |
| 1:16* | 9.57 | 5 | 4 | 5 | 4 | 4 | 4 | 4.33 |

Examples marked with an asterisk (*) are comparative examples

A comparison of the examples according to the invention with the comparative examples clearly shows that the tea stain score TSS is significantly improved by the presence of polycarboxylic polymers in case the builder is MGDA, sodium citrate or GLDA. In contrast, no such improvement was observed for the phosphate-built compositions 1:15 and 1:16. The improvements are observed with both P1 and P2.

### EXAMPLE 2

Comparative examples were prepared consistent with the composition of Examples A and 1 of European patent application EP 1 741 774 A1. The compositions are detailed in Table 5. The same materials were used as in Example 1, unless indicated otherwise in Table 5.

Comparative examples (2:1) and (2:2) were tested in powder format. The material of comparative examples (2:3) and (2:4) was compacted to a tablet before further testing. All four comparative examples were subjected (in duplicate) to the tea stain removal test protocol as detailed in Example 1 above. The resulting tea stain scores TSS are provided in Table 5.

TABLE 5

| | | Examples: | | | | | | | |
|---|---|---|---|---|---|---|---|---|---|
| | | 2:1* | | 2:2* | | 2:3* | | 2:4* | |
| | | R.A.^{(e)} | g | R.A.^{(e)} | g | R.A.^{(e)} | g | R.A.^{(e)} | g |
| Base ingredients: | | | | | | | | | |
| Citrate | A1 | 31.51 | 11.03 | 31.51 | 11.03 | 31.51 | 5.67 | 31.51 | 5.67 |
| Sodium percarbonate^{(a)} | B | 13.66 | 4.78 | 13.66 | 4.78 | 13.66 | 2.46 | 13.66 | 2.46 |
| Polycarboxylate polymer | C | | | | | | | | |
| P1 | | | — | 3.90 | 1.37 | | — | 3.90 | 0.7 |
| P2 | | | — | 1.17 | 0.41 | | — | 1.17 | 0.21 |
| P3^{(b)} | | | — | 0.23 | 0.08 | | — | 0.23 | 0.04 |
| Sodium Carbonate | D | 20.13 | 7.05 | 20.13 | 7.05 | 20.13 | 3.62 | 20.13 | 3.62 |
| Sodium disilicate | | 9.96 | 3.49 | 9.96 | 3.49 | 9.96 | 1.79 | 9.96 | 1.79 |
| Na sulphate | | 7.00 | 2.45 | 7.00 | 2.45 | 7.00 | 1.26 | 7.00 | 1.26 |
| EP/PO Nonionic^{(c)} | E | 4.00 | 1.40 | 4.00 | 1.40 | 4.00 | 0.72 | 4.00 | 0.72 |
| Manganese catalyst^{(d)} | F | | 0.0129 | | 0.0129 | | 0.0066 | | 0.0066 |
| Enzymes | | 2.68 | 0.94 | 2.68 | 0.94 | 2.68 | 0.48 | 2.68 | 0.48 |
| PEG | | 3.11 | 1.09 | 3.11 | 1.09 | 3.11 | 0.56 | 3.11 | 0.56 |
| Perfume | | 0.14 | 0.05 | 0.14 | 0.05 | 0.14 | 0.03 | 0.14 | 0.03 |
| Sum of A, B, C, D, E | | | 27.75 | | 29.61 | | 14.26 | | 15.21 |
| Relationship (R) | S | | 24.94 | | 24.94 | | 12.82 | | 12.82 |
| Tea Stain Score (TSS) | | | | | | | | | |
| Replicate 1 | | | 7.33 | | 7.50 | | 2.17 | | 2.17 |
| Replicate 2 | | | 7.33 | | 7.50 | | 2.17 | | 2.33 |

^{(a)}15.3% Avox
^{(b)}P3 = polycarboxylate with polyethoxylate grafts
^{(c)}EP/PO Nonionic: Dehypon Gra
^{(d)}Specified as the amount of catalyst, not as amount of granule
^{(e)}R.A. = relative amounts, corresponding to wt-% as specified in EP 1 741 774 A1, but leaving out glycerol and dye
*comparative example

The tea stain scores TSS of Comparative examples (2:1) and (2:2) are not significantly different. This shows that for a zero-phosphate machine dish wash composition in unit dose format and in powder form, but where S>16.34 so that relationship R is not satisfied, there is no effect of the presence of polycarboxylate polymers according to the invention on TSS.

Likewise, the tea stain scores TSS of Comparative examples (2:3) and (2:4) are not significantly different. This shows that for a zero-phosphate machine dish wash composition in unit dose format, that is not in powder but in tablet form, there is no effect of the presence of polycarboxylate polymers according to the invention on the TSS.

1. Zero-phosphate machine dish wash composition in unit dose format comprising
a. non-phosphate builder in an amount A, being in the range of 1 to 10 grams, the builder comprising one or more from methylglycine-N,N-diacetic acid and/or one or more salts thereof in an amount A1,
citric acid and/or one or more salts thereof in an amount A2, and
glutamic acid-N,N-diacetic acid and/or one or more salts thereof in an amount A3,
whereby the amounts of the non-phosphate builder and its components are expressed as the molar equivalent amounts of the respective neutralised sodium salts;
b. alkali percarbonate in an amount B, being in the range of 0.06 to 0.7 grams in terms of active oxygen;
c. one or more polycarboxylate polymers with a weight average molecular weight of between 1000 and 100,000, the polymers comprising at least 20 mol-% of acrylate monomers and from 0 to 40 mol-% of maleate monomers, whereby the polycarboxylate polymers are present in an amount C, being in the range of 0.2 to 3 grams, and whereby the weight of the polymers is expressed in terms of the weight of the molar equivalent amounts of their neutralised sodium salts;
d. alkali carbonate, alkali silicates or mixtures thereof in an amount D, being in the range of 1 to 10 grams;
e. one or more nonionic surfactants in a total amount E, being in the range of 0 to 2 grams;
f. a manganese bleach catalyst in an amount F, being in the range of 0.0020 to 0.018 grams, whereby the manganese bleach catalyst is according to formula (I):
[LₙMnₘXₚ]^{z}Y_{q} (I)
wherein Mn is manganese; n and m are independent integers from 1 to 4; each Mn independently has an oxidation state selected from II, Ill, IV and V; X represents a coordination or bridging species; p is an integer from 0 to 12; Y is a counter-ion, the type of which is dependent upon the charge z of the complex which can be positive, zero or negative; the coefficient q is the charge z divided by the charge of Y; and L is a ligand being a macrocyclic organic molecule of the general formula (II) 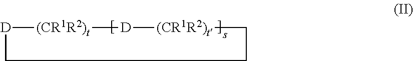
wherein R¹ and R² can each be zero, H, alkyl or aryl; t and t′ are each independent integers from 2 to 3; each D can independently be N, NR, PR, O, or S, wherein R is H, alkyl or aryl; and s is an integer from 2 to 5;
whereby the weight of the bleach catalyst is expressed as the weight of the molar equivalent amount of the complex wherein L is 1,4,7-trimethyl-1,4,7-triazacyclononane, m is 2, X is O²⁻, p is 3, z is 2+, Y is PF₆⁻ and q is 2;
g. and optionally, further ingredients;
whereby the sum of the said amounts A, B, C, D, and E is between 5 and 25 grams;
whereby all amounts are specified with regard to the anhydrous compound; and
whereby the amounts A1, A2, A3, B, and F satisfy the relationship (R):
1.75×A1+1.43×A2+1.54×A3+9.83×B+153×F=S,
wherein S≦16.34 grams
whereby the composition is such that the pH of a solution of 1 wt % of the composition in water has a pH above 9.5 at 20° C.,
and whereby at least 40 wt-% of the composition is in powder form.

2. Composition according to claim 1 wherein at least 80 wt-% of the non-phosphate builder is selected from methylglycine-N,N-diacetic acid (MGDA), one or more salts thereof, citric acid, one or more salts thereof, glutamic acid-N,N-diacetic acid, one or more salts thereof, and mixtures of these acids and salts.

3. Composition according to claim 2 wherein at least 80 wt-% of the non-phosphate builder is methylglycine-N,N-diacetic acid, one or more salts thereof, and mixtures of this acid and these salts.

4. Composition according to claim 2 wherein at least 80 wt-% of the non-phosphate builder is citric acid, one or more salts thereof, and mixtures of this acid and these salts.

5. Composition according to claim 1, wherein the polycarboxylate polymers are selected from polycarboxylate polymers wherein at least 90 mol-% of the monomers are selected from acrylate, maleate, monoethylenically unsaturated alkyl sulphonic acid derivatives, monoethylenically unsaturated polyalkyleneoxide macromers and mixtures thereof.

6. Composition according to claim 1, wherein the polycarboxylate polymers comprise one or more polyacrylate polymers with a weight average molecular weight of between 1000 and 15000, more preferably between 2000 and 9000, even more preferably between 3000 and 5000, wherein the polyacrylate polymer comprises at least 90 mol-% acrylate monomers.

7. Composition according to claim 1, wherein the polycarboxylate polymers comprise one or more polyacrylate-maleate co-polymers comprising from 5 to 40 mol-%, more preferably from 10 to 20 mol-% of maleate monomers.

8. Composition according to claim 1, wherein the amount C of the one or more polycarboxylate polymers is in the range of 0.3 to 2 grams, more preferably 0.4 to 1 grams, even more preferably from 0.5 to 0.8 grams and still more preferably from 0.6 to 0.7 grams based on the weight of the molar equivalent amount of their neutralised sodium salts.

9. Composition according to claim 1 wherein the amounts A1, A2, A3, B, and F satisfy the relationship (R) wherein 12.34≦S≦16.34

10. Composition according to claim 9, wherein 12.34≦S≦15.34, more preferably 12.84≦S≦14.84, even more preferably 13.34≦S≦14.34.

11. Composition according to claim 1 having a tea stain score TSS of at least 4, preferably at least 5, and more preferably at least 6.

12. Use of one or more polycarboxylate polymers for raising the tea stain score TSS of a zero-phosphate machine dish wash composition in unit dose format with respect to the same composition without the polycarboxylate polymers; the polymers having a weight average molecular weight of between 1000 and 100,000 and comprising at least 20 mol-% of acrylate monomers and from 0 to 40 mol-% of maleate monomers, whereby the one or more polymers are present in an amount C, being in the range of 0.2 to 3 grams;
whereby the composition additionally comprises
a. non-phosphate builder in an amount A, being in the range of 1 to 10 grams, the builder comprising one or more from methylglycine-N,N-diacetic acid and/or one or more salts thereof in an amount A1,
citric acid and/or one or more salts thereof in an amount A2, and
glutamic acid-N,N-diacetic acid and/or one or more salts thereof in an amount A3,
whereby the amounts of the non-phosphate builder and its components are expressed as the molar equivalent amounts of the respective neutralised sodium salts;
b. alkali percarbonate in an amount B, being in the range of 0.06 to 0.7 grams in terms of active oxygen;
c. alkali carbonate, alkali silicates or mixtures thereof in an amount D, being in the range of 1 to 10 grams;
d. one or more nonionic surfactants in a total amount E, being in the range of 0 to 2 grams;
e. a manganese bleach catalyst in an amount F, being in the range of 0.0020 to 0.018 grams, whereby the manganese bleach catalyst is according to formula (I):
[LₙMnₘXₚ]^{z}Y_{q} (I)
wherein Mn is manganese; n and m are independent integers from 1 to 4; each Mn independently has an oxidation state selected from II, Ill, IV and V; X represents a coordination or bridging species; p is an integer from 0 to 12; Y is a counter-ion, the type of which is dependent upon the charge z of the complex which can be positive, zero or negative; the coefficient q is the charge z divided by the charge of Y; and L is a ligand being a macrocyclic organic molecule of the general formula (II) 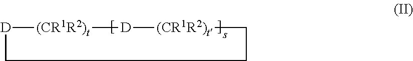
wherein R¹ and R² can each be zero, H, alkyl or aryl; t and t′ are each independent integers from 2 to 3; each D can independently be N, NR, PR, O, or S, wherein R is H, alkyl or aryl; and s is an integer from 2 to 5;
whereby the weight of the bleach catalyst is expressed as the weight of the molar equivalent amount of the complex wherein L is 1,4,7-trimethyl-1,4,7-triazacyclononane, m is 2, X is O²⁻, p is 3, z is 2+, Y is PF₆⁻and q is 2;
f. and, optionally, further ingredients;
whereby the sum of the said amounts A, B, C, D, and E is between 5 and 25 grams;
whereby all amounts are specified with regard to the anhydrous compound; and
whereby the amounts A1, A2, A3, B, and F satisfy the relationship (R):
1.80×A1+1.43×A2+1.23×A3+9.83×B+153×F=S,
wherein S≦16.34 grams;
whereby the composition is such that the pH of a solution of 1 wt % of the composition in water has a pH above 9.5 at 20° C.

13. Use of a composition according to claim 1 for improving tea stain removal upon dishwashing.

14. Use according to claim 13, whereby the improvement is with respect to the same composition without the one or more polycarboxylate polymers.
